(19) United States
(12) Patent Application Publication
(10) Pub. No.: US 2006/0169849 A1
(43) Pub. Date: Aug. 3, 2006

(54) Quick joint without bolts or accessories for cable hangers

(76) Inventor: Gustavo Martin Saavedra, Moreno (AR)

Correspondence Address: Ronald Abramson;Hughes Hubbard & Reed LLP, One Battery Park Plaza, New York, NY, 10004-1482, US

(21) Appl. No.: 11/313,559

(22) Filed: Dec. 20, 2005

(30) Foreign Application Priority Data
Dec. 20, 2004 (AR) 20040104776

(51) Int. Cl. F16L 3/00

(52) U.S. Cl. 248/49

(57) ABSTRACT

Quick joint which is comprised by a laminar body folded 90°, having “L” section, the height of which is consistent with the height of the side wing corresponding to the profile of the hanger section to be joined; along the upper edge of said body a small arched flange is formed, while the angular 90° fold is effected at the opposite edge to the same side towards which said flange extends; said quick joint laminar body being provided, along with the openings existing at the base, with corresponding projecting embedded shoulders acting as snap fit anchoring resilient means for operational engagement, fitting into said openings. The height of the side face of the quick joint laminar body is slightly larger than that corresponding to the wing of the involved hanger, while the width of the laminar body is, at most, half of the width of the hangers being joined.

This application claims the benefit of Argentinean Patent Application No. 20040104776, filed on Dec. 20, 2004.

### FIELD OF THE INVENTION

The instant invention relates to cable hangers in general and, more particularly, to a quick joint without bolts or special fittings, affording an instantaneous joint means for cable hanger sections of any of the existing shapes.

### PRIOR ART

Several ways of joining cable hanger sections are already known, specially those designed for laying electrical cables in industrial and commercial installations, hangers which are supported from the walls or suspended from the roof.

Among the mentioned joints, the most common is comprised by a perforated sheet which is fixed joining the ends of contiguous hangers, by means of corresponding bolts and nuts being screwed particularly along the side wings. A safe joint requires at least a pair of bolts for each side of the joint, in order to remain properly aligned, i.e., at least four bolts, their nuts and the corresponding washers are required.

Another known way of joining hanger sections is by the use of an additional fixing fitting for securing the joint plate to the hanger.

### SUMMARY OF THE INVENTION

None of the means conventionally used in the industry constitute an antecedent to the object of the instant invention, which is mainly involved in the joint of straight sections, with the advantage of the quick joint described straddling the ends of said sections without the addition of any kind of bolt or auxiliary accessories, since the joint is maintained firmly consolidating the joint due to its special structure, by means of the snap fit obtained in a practically instantaneous way.

An object of the invention is obtaining a quick joint as described below by means of which the immediate joint of rectilinear sections of cable hangers is possible, without requiring the use of bolts or fittings for forming a solid joint of said hanger sections which, as known, are made of perforated sheet with side wings.

The use of the quick joint means of the instant invention represents important savings, due not only to the elimination of any kind of bolts and fittings usually required to obtain a safe joint, but also due to the substantial savings in the time required for preparing the installation.

In order to attain the mentioned advantages, the device permitting the instantaneous joint at the meeting points of sections of said cable hangers, is comprised by a laminar body folded 90°, the height of which is consistent with the height of the side wing corresponding to the profile of the hanger section to be joined. Along the upper edge a small arched flange is formed by embedding, while the 90° angular fold is effected at the opposite edge to the same side in which said flange extends. Cable hangers of the invention are provided along their whole length with multiple drilled openings distributed regularly over the whole surface of the base and also at the side wings. Generally, some openings are circular, other quadrangular and others elongated, being distributed longitudinally. The longer axes may be longitudinally directed or they may be alternated, longitudinally and transversally. Therefore said quick joint laminar body is provided as well as said openings, with corresponding embeddings forming shoulders or relieves which are operatively engaged with those existing at the ends of each section, wherein they fit forming pressure anchoring resilient means.

Such shoulders may be located at both folded surfaces of the joint body or only at its angularly folded component, coinciding with the base plane of the hanger.

A preferred embodiment of the invention will be described below, with reference to the accompanying drawings. This description should be considered merely as a non limiting example.

### BRIEF DESCRIPTION OF THE DRAWINGS

FIG. 1 is a perspective view of the body for quick joint of two hanger sections, according to the invention.

FIG. 2 is a perspective view, in successive pictures, of two fragments of hanger sections and the required joint bodies, representing the handling sequence from the initial status to the final status, for anchoring and engaging contiguous sections, using the arrangement of the invention.

In the appended drawings the same reference symbols designate the same or equivalent parts.

### DETAILED DESCRIPTION OF THE INVENTION

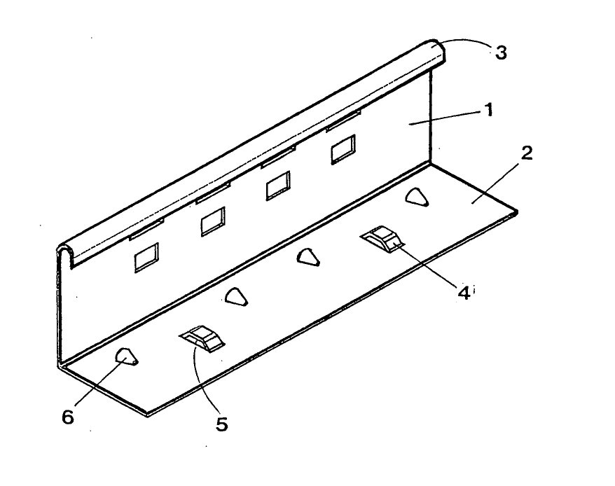

According to FIG. 1, the quick joint of the invention is comprised by an “L” section laminar body formed by a side face 1 having some openings which may be used, as established by international safety standards, for ground connection. As required by the installing electrician, such openings may be used for bolt connections with adjacent hanger sections.

The laminar body is completed with base 2. The two faces 1 and 2 are mutually folded in an orthogonal way. The height of side face 1 is consistent with the heights of -e- and -f- of hangers -E- and -F- to which the joint is applied. The base width of each quick joint laminar body is at most half the width of the hangers being joined. The height of the side face 1 of the joint body is slightly larger than the height of the hanger wing, for taking into account the thickness of the forming material.

Along the upper edge of the side face 1 a small arched flange 3 is embedded, folded towards the same side of the base 2.

At the base section 2 of the quick joint means there are various anchoring projecting devices, represented by shoulders projecting from the surface of the sheet used for manufacturing the part, which, in this embodiment, are obtained by punching or stamping the metal material. Shoulders designated -4- raise in an arched form from a rectangular base 5 and those designated 6 which are elongated and narrower, correspond with rectangular openings 7 and elongated openings 8, respectively, at the base -e- of the hanger.

Shoulders 4 are preferably formed by two side inclined planes which end at a planar surface.

### OPERATION

The functional and operational relationship of the parts forming the invention is indicated below.

The functional relationship is very simple and may be easily followed based on the drawings of FIG. 2.

In the assembling sequence shown in FIG. 2, picture No. 1 shows the two ends of hanger sections -E- and -F- one in front of the other for engagement with the quick joint means to be fixed to wings -e- and -f-. Picture 2 shows abutment of such means, and picture 3 shows the beginning of the fixing operation placing the quick joint on the hanger, such that the embedded flange 3 bears on the upper edge -g- at the point where both profiles -E- and -F- meet. Picture 4 shows its turning around the edge approaching the quick joint part towards the hangers bases, pushing it gently (picture 5) to the anchoring position of the quick joint means into openings 7 and 8 wherein shoulders 4 and 6 are snap fitted. This operation is repeated at the other side of the hangers, thus finishing anchoring as shown in picture 6.

If quick joint means were to be removed, the point of a tool, such as a screw driver, should be introduced, between the hanger base and the body of the angular joint.

The invention has been described in connection with one of the constructive possibilities of the invention and with its operation, the scope of the invention being only limited by the appended claims.

1. Quick joint without bolts or accessories for cable hangers, of the type constituted by sections of a determined length, with a “U” shaped section, formed by a base and side wings, wherein at least at the central base between both wings, a plurality of openings distributed along the length is drilled, characterized in that said quick joint is comprised by a “L” section laminar body folded 90°, the height of which corresponds to the height of the side wing corresponding to the profile of the hanger section to be joined; along the supper edge of said body a small arched flange is formed, while the 90° angular fold is effected at the opposite edge to the same side towards which said flange extends; said quick joint laminar body along with the openings existing at the base mating with corresponding projecting shoulders forming snap fit anchoring resilient means for operational engagement fitting into said openings.

2. Quick joint without bolts or accessories for cable hangers as claimed in claim 1, wherein said quick joint laminar body has a height of the side face slightly larger than that corresponding to the hanger wing to which it is applied, while the width of the quick joint laminar body is at most half of the width of the hangers being joined.

3. Quick joint without bolts or accessories for cable hangers as claimed in claims 1 and 2, wherein said shoulders are formed by two side inclined planes ending at a planar surface.

4. Quick joint without bolts or accessories for cable hangers as claimed in claim 1 and following claims, wherein said shoulders formed at the quick joint body project over the joint body adopting a substantially arched rectangular form.

5. Quick joint without bolts or accessories for cable hangers as claimed in claim 1 and following claims, wherein said flange and the shoulders projecting from the quick joint base are formed by embedding or stamping the metal laminar body, and wherein said shoulders project from the face opposite to the hanger base.

6. Quick joint without bolts or accessories for cable hangers as claimed in claim 1 and following claims, wherein said shoulders formed at the quick joint body are located at both body folded surfaces as well as only at the base thereof coinciding with the hanger base plane.

7. Quick joint without bolts or accessories for cable hangers as claimed in claim 1 and following claims, wherein the quick joint is located at both wings of the hanger.
